(19) United States
(12) Patent Application Publication
(10) Pub. No.: US 2020/0224784 A1
(43) Pub. Date: Jul. 16, 2020

(54) LOW-VOLTAGE MICROFLUIDIC ACTUATOR DRIVEN BY TENSION MODIFICATION.

(71) Applicant: University of Utah Research Foundation, Salt Lake City, UT (US)

(72) Inventors: Nazmul Hasan, Salt Lake City, UT (US); Fariha Khan, Salt Lake City, UT (US); Shashank Pandey, Salt Lake City, UT (US); Aishwaryadev Banerjee, Salt Lake City, UT (US); Hanseup Kim, Salt Lake City, UT (US); Carlos H. Mastrangelo, Salt Lake City, UT (US)

(21) Appl. No.: 16/629,294

(22) PCT Filed: Jul. 9, 2018
(86) PCT No.: PCT/US18/41307

§ 371 Date: Jan. 7, 2020

Related U.S. Application Data
(60) Provisional application No. 62/529,961, filed on Jul. 7, 2017.

(51) Int. Cl. F16K 31/04; F15C 3/04; F03G 7/06

(52) U.S. Cl. CPC F16K 31/047; F03G 7/065; F15C 3/04

(57) ABSTRACT

A tension driven actuator (100) comprises a support structure (102) formed of a peripheral bounded wall (118) at least partially defining a fluid chamber (112), and a first elastic diaphragm (116) attached, under tension, to the support structure (102) and enclosing the fluid chamber (112) with the support structure (102). A pressurized fluid (110) is disposed in the fluid chamber (112), and a tension modifier structure (108) is attached to the first elastic diaphragm (116), and is under tension with the first elastic diaphragm (1 16). In response to application of an electrical field to the tension modifier structure (108), the tension modifier structure (108) transitions from a diaphragm tension position to a diaphragm relaxed position, such that the tension modifier structure (108) deforms and contracts in size, thereby reducing tension of the first elastic diaphragm (116) such that fluid pressure causes deflection of a portion of the first elastic diaphragm (116). The tension driven actuator (100) can be a variably controlled optical lens, or an actuator for other purposes.

### RELATED APPLICATIONS

This application claims priority to U.S. Provisional Application No. 62/529,961, filed Jul. 7, 2017 which is incorporated herein by reference.

### BACKGROUND

Many types of microactuators utilize membranes or diaphragms that are deflected by a force. Such actuators are commonly used for opening or closing of microvalves with injection or removal of a fluid. Actuation forces can be generated using several electromechanical transduction mechanisms.

One prior approach uses electromagnetic forces produced by solenoid coils with permalloy plungers to generate an actuation force. Actuation forces have also been generated electrostatically between two conducting plates separated by a dielectric material. Such electrostatic actuators consume very little electrical power, but are limited for use in various applications because of their resulting small forces and deflections.

Actuation forces have also been generated using piezoelectrics. Piezoelectric actuators consume very little electrical power and can produce large force; however, the deflection of piezoelectric actuators is small unless in stacked or bimorph form, which make them bulkier and not feasible in some micro applications.

Other force generation mechanisms include bimetallic, thermopneumatic, and shape memory alloy (SMA) springs as actuators for various purposes and in various configurations.

The above actuation approaches have been incorporated in some applications to deflect a membrane or diaphragm by electrically controlling the amount of deflection of the membrane or diaphragm. However, such configurations require significant fabrication and electromechanical integration complexity, rendering them infeasible or impractical for certain applications.

In the realm of variable focus lenses, prior approaches include a cylindrical bladder with flexible membrane walls that is filled with a transparent optical fluid. The shape of the lens (and therefore the focal length) is changed by pumping fluid in and out of the lens from an external fluid supply source, which causes deflection of one or more of the membrane walls. Some commercially available examples have manually adjusted liquid filled eyeglass capable of adjusting the lens power between −6 to +3 diopters. A major issue with such lenses is the actuation mechanism size and weight, which is impractical for many eyewear applications.

Several other actuation approaches have been tried with various degrees of success to vary a focal length of a lens, including the use of external motors, electrostatic forces, electrophoretic motion, and more recently piezoelectrics. The largest aperture commercially available continuously adjustable variable-focus liquid lens is manufactured by Optotune with a clear aperture of 20 mm, and the largest electrically tunable liquid lens has aperture of 10 mm. However, none of these lenses has sufficient aperture for commercially useful eyeglasses. Larger aperture fluidic systems have been realized, but they are not practical for lightweight applications without careful consideration of the storage of the lens liquid in external fluid supply chambers. The realization of a lightweight adjustable focus lens that works well for eyeglasses is still an unsolved problem.

### SUMMARY

The present disclosure sets forth a tension driven actuator comprising a support structure formed of a peripheral bounded wall at least partially defining a fluid chamber, and a first elastic diaphragm attached, under tension, to the support structure and enclosing the fluid chamber with the support structure. A fluid is disposed in the fluid chamber, and a tension modifier structure is attached to the first elastic diaphragm, such that the structure is under tension with the first elastic diaphragm. In response to application of an electrical field to the tension modifier structure, the structure transitions from a diaphragm tension position to a diaphragm relaxed position, such that the structure deforms and contracts in size, thereby reducing tension of the first elastic diaphragm such that fluid pressure causes deflection of a portion of the first elastic diaphragm.

In one example, the tension driven actuator comprises an enclosing portion supported about the support structure, and that further encloses the fluid chamber. The enclosing portion can comprise a rigid support structure coupled to, or formed as part of, the support structure. Alternatively, the enclosing portion can comprise a second elastic diaphragm.

In one example, the tension modifier structure can be a metallic structure which can comprise an SMA coil, piezoelectric coil or other material which can have two or more turns. The tension modifier can be attached to or embedded within the first elastic membrane.

In one example, the fluid is pressurized, and defines a fixed fluid volume before and after deflection of the first elastic diaphragm.

The present disclosure sets forth a focusing lens system comprising at least one tension driven actuator as recited above (or in other examples described herein). In these cases, the first elastic diaphragm and an opposing second elastic diaphragm are optically transparent.

The present disclosure also sets forth a microfluidic valve comprising at least one tension driven actuator as recited above (or in other exampled described herein) oriented within a microfluidic channel and positioned such that the channel is closed in a diaphragm relaxed position and open in the diaphragm tension position.

In one specific example, the present disclosure sets forth a tension driven actuator for dynamically modifying a focal length comprising: a support structure formed of a peripheral bounded wall at least partially defining a fluid chamber; a first transparent elastic diaphragm attached, under tension, to one side of the support structure; a second transparent elastic diaphragm attached to another side of the support structure, such that the support structure and the first and second transparent elastic diaphragms define a fluid chamber; a transparent fluid disposed in the fluid chamber, and the transparent fluid is pressurized to apply a force to the first and second transparent elastic diaphragms; a tension modifier structure (e.g. SMA or piezoelectric coil) attached to the first transparent elastic diaphragm; and a power source electrically coupled to the coil. Thus, the coil deforms and contracts upon application of an electrical field to the coil, thereby reducing tension of the first transparent elastic diaphragm such that fluid pressure causes deflection of a portion of the first transparent elastic diaphragm to modify a focal length of the tension driven actuator.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1A is a side cross sectional view of a tension driven actuator in a diaphragm tension position (i.e., not yet actuated), in accordance with an example of the present disclosure.

FIG. 1B is the tension driven actuator of FIG. 1A in a diaphragm relaxed position (i.e., actuated).

FIG. 2A is a side cross sectional view of a first elastic diaphragm having a shape memory alloy (SMA) coil that can be incorporated with the tension driven actuator of FIG. 1A through forming grooves in the diaphragm, in accordance with an example of the present disclosure.

FIG. 2B is a side cross sectional view of a first elastic diaphragm having an embedded SMA coil that can be incorporated with the tension driven actuator of FIG. 1A, in accordance with an example of the present disclosure.

FIG. 3 is an isometric view of eyeglasses having a tension driven actuator for modifying a focal length, in accordance with an example of the present disclosure.

FIG. 4A is a side cross sectional view that illustrates separated components for making a tension driven actuator, in accordance with an example of the present disclosure.

FIG. 4B illustrates assembly of the components of the tension driven actuator of FIG. 4A where the first elastic diaphragm is linearly expanded to secure under tension.

FIG. 4C illustrates filling the tension driven actuator of FIG. 4B with a suitable fluid.

FIG. 5 is a graph showing displacement of a tension driven actuator as a function of voltage, in accordance with an example of the present disclosure.

FIG. 6 is a graph showing displacement of a tension driven actuator as a function of voltage for two different fluid pressures of the tension driven actuator, in accordance with an example of the present disclosure.

FIG. 7 show images of the results of optical lensing associated with four different voltages applied to a particular tension driven actuator, in accordance with an example of the present disclosure.

FIG. 8A is a schematic side view of a tension driven actuator in the form of a microfluidic valve actuator and in a diaphragm tension position, in accordance with an example of the present disclosure.

FIG. 8B is the microfluidic valve actuator of FIG. 8A in a diaphragm relaxed position which results in a closed or partially obstructed channel.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

Definitions

In describing and claiming the present invention, the following terminology will be used.

The singular forms “a,” “an,” and “the” include plural referents unless the context clearly dictates otherwise. Thus, for example, reference to “a coil” includes reference to one or more of such materials and reference to “applying” refers to one or more such steps.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 0.5%, and in some cases less than 0.01%.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, and combinations of each.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Microfluidic Actuator driven by Tension Modification

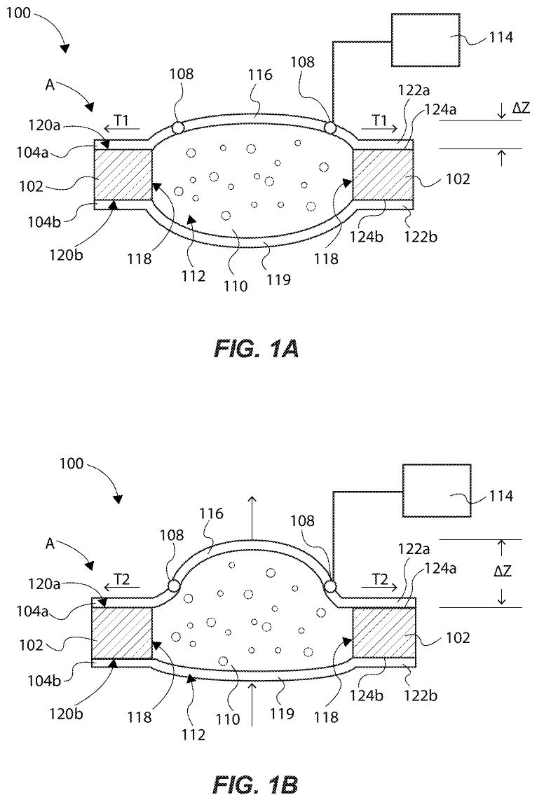

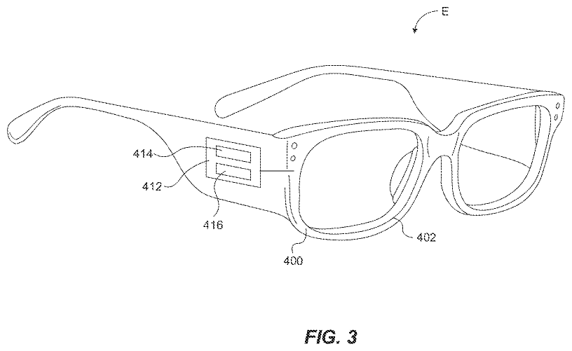

FIG. 1A illustrates a tension driven actuator 100 in a tension diaphragm position A (i.e., prior to actuation), and FIG. 1B illustrates the tension driven actuator 100 in a relaxed diaphragm position B (i.e., upon actuation). The tension driven actuator 100 can be incorporated as a variable focusing lens of eyeglasses E of FIG. 3, as further discussed below.

As an overview, the tension driven actuator 100 can comprise a support structure 102, first and second elastic membranes or diaphragms 104a and 104b attached to either side of the support structure 102, and a metallic structure 108 attached to or embedded in the first elastic diaphragm 104a. A fluid 110 can be disposed in a fluid chamber 112, and can be pressurized sufficient to at least partially deflect the first elastic diaphragm 104a. The first elastic diaphragm 104a and the metallic structure 108 (e.g., SMA coil) can be pulled or placed under tension prior to being attached to the support structure 102. In the tension diaphragm position A of FIG. 1A, fluid pressure applied by the fluid 110 can exert a force to the first and second elastic diaphragms 104a and 104b, such that the first and second elastic diaphragms 104a and 104b tend to expand or bulge outwardly, because of the elastic nature of the elastic diaphragms and the fluid pressure applied thereon.

Note that the first elastic diaphragm 104a may expand or bulge to a lesser degree than the second elastic diaphragm 104b, because the first elastic diaphragm 104a is under tension when attached to the support structure 102. The metallic structure 108 can be coupled to a power source 114, such that, in response to application of an electrical field, the metallic structure 108 transitions the tension drive actuator 100 from the diaphragm tension position A (FIG. 1A) to the diaphragm relaxed position B (FIG. 1B). Accordingly, the metallic structure 108, typically being an SMA coil, deforms and contracts in size upon being heated by electrical power. That is, a wire length of the metallic structure 108 reduces, thereby deforming and contracting the size or diameter or shape of the metallic structure 108. This transition or contraction of the metallic structure 108 causes a reduction in tension of the first elastic diaphragm 104a, such that fluid pressure from the fluid 110 causes deflection (or relaxation) of a middle portion 116 of the first elastic diaphragm 104a, as illustrated in FIG. 1B, thereby actuating the tension driven actuator 100. The second elastic diaphragm 104b may deflect as well due to the relaxation of the tension of the first elastic diaphragm 104a, because tension about the middle portion 116 is less than a tension of a middle portion 119 of the second elastic diaphragm 104b, as further detailed below.

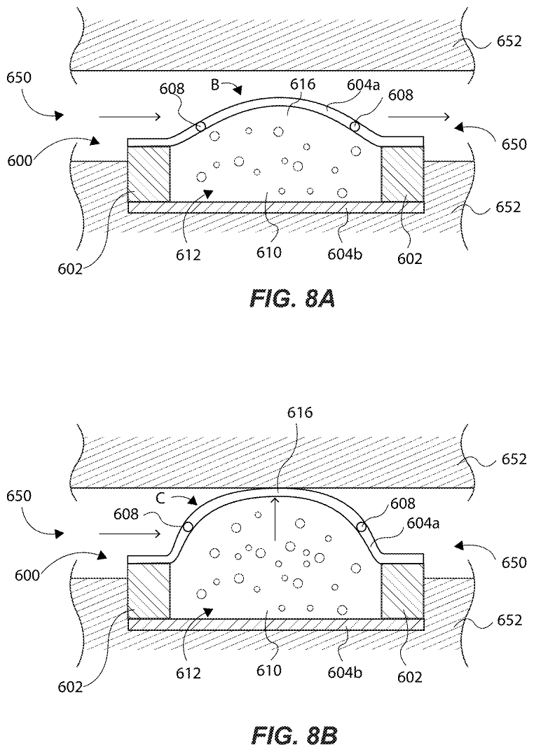

Such deflection of the first and second elastic diaphragms 104a and 104b can be used to modify a focal length where the tension driven actuator 100 is used as a focusing lens, or to generate an actuation force for another purpose. Accordingly, as a focusing lens, the tension driven actuator 100 can be operated to dynamically modify a focal length by varying an amount of voltage applied to the metallic structure 108, as further detailed below. As a pure actuator, a relatively large actuation force can be generated by a tension driven actuator (e.g., 600 of FIG. 8A) from a relatively small voltage, as also detailed below. In both of such applications, the volume or amount of fluid in the fluid chamber does not change before actuation or after actuation of the tension driven actuator, because the fluid chamber comprises a fixed fluid volume. Actuation is driven by tension, not by adding or removing fluid. This “tension driven” configuration drastically reduces the complexity of manufacturing and operating the tension driven actuators exemplified herein. These and other advantages are discussed below in further detail.

In one example, the support structure 102 can be part of a frame of eyeglasses E (FIG. 3), or it can be a separate wall such that a complete lens unit can be inserted into a corresponding eyeglass frame. The support structure 102 can be part of another system, such as a microfluidic valve system (see e.g., FIG. 8A). The support structure 102 can be formed of a peripheral bounded wall 118 that at least partially defines the fluid chamber 112. The peripheral bounded wall 118 can have linear and/or radial surface profiles, or other suitable shapes or profiles. In one example associated with eyeglasses, the support structure 102 can have an inner radius of approximately 18 mm and outer radius of approximately 21 mm, although these values can vary depending on the design of the actuator. As a general guideline, the inner radius can range from about 10 mm to about 30 mm, and most often from about 15 mm to about 22 mm. Similarly, the thickness can vary depending on the desired focal length range or actuation distance but typically define a peripheral thickness of the fluid chamber 112. As a general rule, support structures can have a thickness from about 0.5 mm to about 15 mm and most often from about 1 mm to about 6 mm. The support structure 102 can be comprised of a rigid or semi-rigid material, such as metals, polymers such as acrylics, composites, glass, and the like. In some examples, the support structure can be a rigid plastic such as PMMA (polymethylmethacrylate).

The support structure 102 can comprise a first side 120a and an opposing second side 120b. The first elastic diaphragm 104a can be attached to the first side 120a, while the second elastic diaphragm 104b can be attached to the second die 120b, as shown. In this manner, a peripheral end portion 122a of the first elastic diaphragm 104a can be attached (e.g., via silicone adhesive) to a first attachment surface 124a of the first side 120a of the support structure 102. Similarly, a peripheral end portion 122b of the second elastic diaphragm 104b can be attached to a second attachment surface 124b of the second side 120b of the support structure 102. Silicone adhesive can provide effective attachment of the elastic diaphragms, although other adhesives such as cyanoacrylates can also be used. Furthermore, other mechanisms such as, but not limited to, mechanical clamping, surface activated direct bonding, and the like can also be used to secure the elastic diaphragms to the support structure.

Note that the second elastic diaphragm 104b can be considered an enclosing portion because it encloses the fluid chamber and forms a bottom boundary. However, in another example the second lower elastic diaphragm can be replaced by a rigid support structure described below regarding FIGS. 8A and 8B which also functions as an enclosing portion.

The elastic diaphragms exemplified herein can be comprised of any suitable elastic membrane or diaphragm, such as polydimethylsiloxane (PDMS) elastic membranes, flexible glass membranes, flexible silicon nitride membranes, and elastic silicone rubber membranes. The elastic diaphragms exemplified herein can be optically transparent, or can be opaque, depending on the application of use. The Young modulus of elasticity the elastic diaphragms can vary depending on curing cycle and base to curing agent mixture ratio, in examples of using a curable PDMS membrane. In such examples, the Young modulus of elasticity can range from 500 kPa to 1 MPa, and in some examples can range from 200 kPa to 100 MPa. In one example, the elastic diaphragms exemplified herein can be approximately 1.5 mm thick, although generally the thickness can range from 0.50 mm to 2 mm, and most often from 0.5 to 1.5 mm.

The metallic structures exemplified herein (e.g., 108, 208, 308, 608) can be an SMA coil having one or more turns embedded or attached to the first elastic diaphragm. As an SMA coil formed of a wire, the turns can be adjacent or biases to each other, and situated along a common plane. The SMA coil can include a plurality of substantially concentric coil loops. In some cases, the number of coil loops can range from 2 to 15, and most often from 2 to 8, depending on the SMA material chosen, desired deflection, etc. Although specific dimensions can vary, SMA wire can generally have a wire diameter from 30 μm to 1000 μm and most often from 50 μm to 300 μm.

The coil loops can be oriented on the first elastic diaphragm so as to not obstruct a line of sight and can most often be oriented in an outer perimeter region of the first elastic diaphragm. Some distance between the support structure and the coil loops can be maintained. However, typically the coil loops can be centrally oriented within from about 50% to about 98% of a radius of the inner wall of the support structure, and often from about 60% to about 90%.

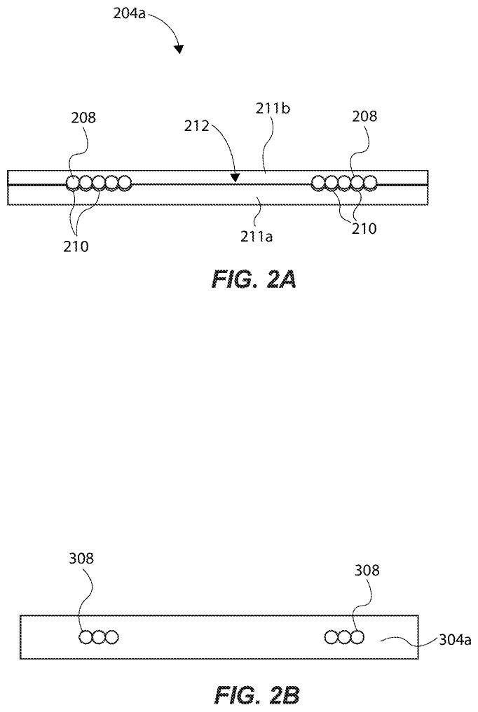

As illustrated in FIG. 2A, a particular metallic structure 208 in the form of an SMA coil can comprise six turns and can be embedded in the elastic diaphragm. The metallic structure 208 can be attached or coupled to spiral grooves 210 of the first elastic diaphragm 204a, so that contraction of the SMA coil causes a pulling or contraction force to the elastic diaphragm.

The example of FIG. 2A can be manufactured by creating an acrylic mold (not shown) having a recess or cavity shaped corresponding to the desired shape and size of a particular first elastic diaphragm. Then, spiral molded grooves are laser cut into the acrylic mold about the cavity. Each spiral mold groove can be approximately 0.5 mm deep and approximately 170 micrometers wide, and the distance between two neighboring grooves can be approximately micrometers 450 micrometers. After making the acrylic mold (having the cavity and the spiral molded grooves), a flowable PDMS (or other elastic material) can be mixed with base curing agent (e.g., SYLGARD 184 Silicone Elastomer, and in a 10:1 ratio), and then poured into the cavity of the acrylic mold to make a first layer 211a having spiral grooves 210. In one example, this first layer 211a can be heated at 45° C. for 5 hours to cure. Once cured, the first layer 211a can be removed from the acrylic mold, and then the metallic structure 208 (e.g., 100-310 micrometer diameter SMA wire) can be inserted in between the ridges of the spiral grooves 210 of the first layer 211a. Then, a second layer 211a (e.g., PDMS material) can be spin cast (or otherwise disposed over) the first layer 211a, thereby forming the first elastic diaphragm 204a that includes the metallic structure 208 embedded therein. Lead wire portions (not shown) of the SMA coil can extend out from the first elastic diaphragm 204a to allow electrical coupling to a control system having a power source and microprocessor (see e.g., FIG. 3) for controlling an amount of voltage applied to the metallic structure 208.

FIG. 2B illustrates another type of first elastic diaphragm 304a having a metallic structure 308 embedded therein, which can be an SMA coil having 3 turns, for instance, and a larger wire diameter than the SMA coil of FIG. 2A. Once the coil is formed or positioned in space or on a surface, a PDMS material can be flowed over and around the metallic structure 308 to embed the metallic structure 308 into the first elastic diaphragm 304a. In another example, the PDMS material can be flowed in two steps to allow the metallic structure to be fully encapsulated within the first elastic diaphragm.

A shape memory alloy is an alloy that remembers is original shape, and that when deformed, returns to its pre-deformed state when heated (e.g., via electrical power). Shape memory alloys are very lightweight solid-state devices that can be used as actuators, such as SMA springs. Thus, when the SMA coils of the present disclosure are pre-stretched or under tension with an elastic diaphragm when attached to a support structure, the SMA coil has been deformed, and therefore will return to its pre-deformed state when heated, thereby contracting and radially pulling inwardly on the elastic diaphragm to reduce its tension, as further discussed in the examples herein. Non-limiting examples of suitable SMA material include copper-aluminum-nickel, nickel-titanium (NiTi) alloys, Cu—Zn—Al, Cu—Al—Ni, Fe—Mn—Si, Ag—Cd, Au—Cd, Cu—Sn, Cu—Zn—X (X=Si, Al, Sn), Fe—Pt, Mn—Cu, Co—Ni—Al, Co—Ni—Ga, Ni—Fe—Ga, Ti—Nb, Ni—Ti—Hf, Ni—Ti—Pd, Ni—Mn—Ga, and the like. Non-limiting examples of suitable piezo-electric materials can include barium titanate, lead zirconate titanate, potassium niobate, sodium tungstate, quartz, lithium niobate, gallium arsenide, zinc oxide, aluminum nitride, sodium potassium niobate, bismuth ferrite, sodium niobate, bismuth titanate, sodium bismuth titanate, and the like. Similarly, some polymer materials and organic nanostructures can also exhibit electrically responsive shape change behavior such as polyvinylidene fluoride, diphenylalanine peptide nanotubes, and the like.

Generally speaking, and with continued reference to FIGS. 1A and 1B, deflection of the middle portion 116 of the first elastic diaphragm as a function of the applied voltage to the metallic structure 108 can be measured optically. In the example where the first and second elastic diaphragms 104a and 104b are optically transparent membranes, they deflect when voltage is applied to the metallic structure 108 as shown in FIG. 1B. The tension driven actuator 100 changes its shape, and the phase of incoming light creates a lensing effect. The overall membrane deflection, Az of the first elastic diaphragm 104a is approximately proportional to the optical power change, as indicated in equation (1).

$$Z = \frac{Δ {P}_{optical} \cdot {r}^{2}}{4 \cdot ( n - 1 )} \qquad ( 1 )$$

Here, ΔP_{optical} is the change of lens optical power, r is the radial aperture of the lens (e.g., as defined by the peripheral bounded wall 118), and n is index of refraction of the fluid 110 (e.g., glycerin having an index of 1.47). The lens optical power can be measured using a Shack-Hartmann (SH) sensor from Thorlabs (WFS150-7AR), although other devices could be used.

When a voltage is applied to the metallic structure 108 (e.g., SMA coil), resistive heating occurs and the SMA coil changes its phase from martensite to austenite state, which contracts the SMA coil in length (i.e., the total wire length of the coil from end to end). The contraction of the SMA coil results in an inward force along the plane of the first elastic diaphragm 104a, which reduces the tension on the bulk or middle portion 116 of the first elastic diaphragm 104a. Such contraction changes the net tension (T1-T2) of the first elastic diaphragm 104a, which makes it bulge as in FIG. 1B and according to equation (2).

$$Δ z \approx \frac{{P}_{o}}{2 ( {T}_{o} - {T}_{w} )} \approx \frac{P ( Δ z )}{2 ( {T}_{o} - a \cdot {V}^{n} )} \qquad ( 2 )$$

Note that Tₒ is the initial tension of the first elastic diaphragm 104a of FIG. 1A, and T_{w} is the electrically controlled SMA coil tension, a is an empirical constant which depends of the actuator material and structure of the device, and V is the applied voltage. The pressure Pₒ is the initial fluid pressure in the fluid chamber 112. For a fixed pre-stretching, the degree of such inward force (i.e., deflection of the first elastic diaphragm 104a) depends on the diameter of the SMA coil and its number of turns. If the SMA coil contraction force is large, then SMA coil contraction introduces an effective SMA coil induced tension, hence equation (3).

$$( 3 )$$

This is subtracted from the membrane pre-stretched tension (T1). Here, Δl is the contraction of the SMA coil in a radial direction, and l is the initial distance of the SMA coil from its center, and Eₘ is the Young's modulus of the first elastic diaphragm 104a, and tₘ is the thickness of the first elastic diaphragm 104a.

As mentioned above, FIG. 3 illustrates a pair of eyeglasses E comprising a frame 402 and at least one tension driven actuator 400, such as the tension driven actuator described herein. The frame 402 can support a control system 412 having a power source 414 and a microcontroller 416 for controlling a focal length of the tension driven actuator 400 being operated as a focusing lens. The power source 414 (e.g., rechargeable battery) can be electrically coupled to a metallic structure (e.g., SMA coil) of the tension driven actuator 400, and the microcontroller 416 can be electrically coupled to the power source 414 for controlling an amount of voltage applied to the metallic structure. Any suitable low-power microcontroller may be used. The microcontroller 416 can optionally have a wireless interface that wirelessly communicates with an external computer system, such as a smart phone or tablet via a Bluetooth, BLE (or other wireless protocol) connection. Thus, a custom developed software application (for android and iOS devices) can be configured to control the focal point of the lenses of the eyeglasses by causing the microcontroller 416 to apply a voltage to a tension driven actuator of each lens according to a particular focal length desired based on a distance to an object viewed by the wearer and a user baseline focal length or his eyeglass prescription. Alternatively, the microcontroller 416 can be programmed to control a focal length of the tension driven actuator(s) via a smart phone application. The application is used to upload user settings such as the eyewear prescription. The type of vision defect (farsightedness, nearsightedness, and other types), as well as parameters related to the speed of the control loop (how often the adaptive lenses are updated), distance measuring options, filtering options, extended battery life options, and various other parameters.

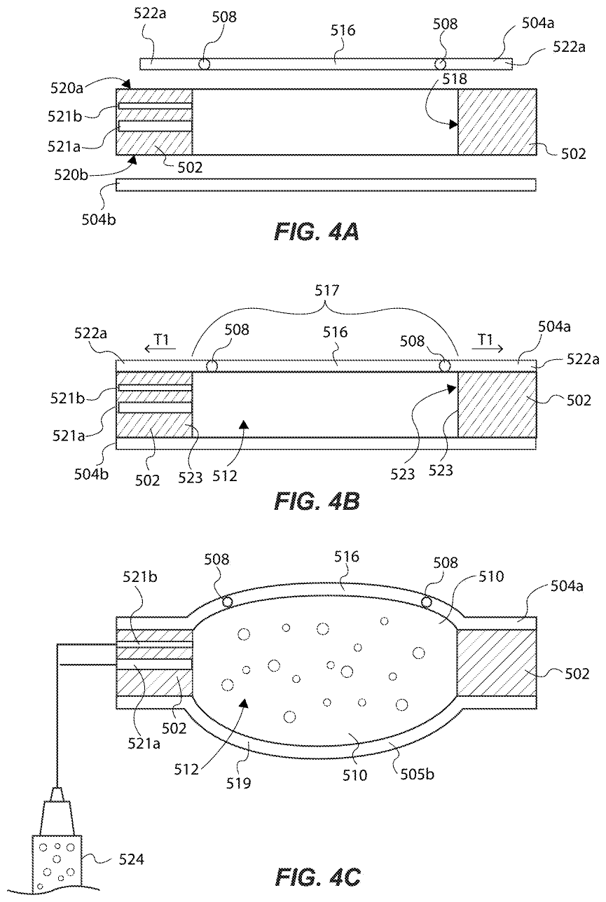

FIGS. 4A-4C illustrate a method of assembling or making a tension driven actuator 500, such as can be implemented for making the tension driven actuators described herein.

In FIG. 4A, the tension driven actuator 500 can be formed with a support structure 502 having a peripheral bounded wall 518, and having first and second opposing sides 520a and 520b. First and second fluid ports 521a and 521b can be formed through the support structure 502 for injection of pressurized fluid, as detailed below. A first elastic diaphragm 504a can comprise the same or similar properties as the first elastic diaphragm 104a described above. Accordingly, a metallic structure 508 (e.g., an SMA coil) can be attached to or embedded in the first elastic diaphragm 508a, such as described regarding the examples of FIGS. 2A and 2B. A second elastic diaphragm 504b can comprise the same or similar properties as the second elastic diaphragm 104b described above, and can be attached (e.g., via silicone adhesive) to the second side 520b of the support structure, and can be attached under some amount of tension.

The first elastic diaphragm 504a, and the embedded metallic structure 508, can be pre-stretched or placed under tension in a radial or outward direction (see arrows T1 of FIG. 4B), and then attached to the first side 520a of the support structure 502. Thus, as described above, the first elastic diaphragm 504a and the metallic structure 508 are under an amount of desired or selected tension during assembly of the tension driven actuator 500. A fluid chamber 512 is now defined by the first and second elastic diaphragms 504a and 504b being attached to opposing sides of the support structure 502. Note that a peripheral end portion 522a of the first elastic diaphragm 504a is attached to the support structure 502, such that a middle section 517 of the first elastic diaphragm 504a is situated about the area defined by an inner surface 523 of the peripheral bounded wall 518 of the support structure 502. Thus, proximate or adjacent such middle section 517, a portion of the first elastic diaphragm 504a is anchored or bounded to the first side 520a of the support structure 502 adjacent the fluid cavity 512, while the middle section 517 is generally free to elastically deform and deflect. Accordingly, the metallic structure 508 is supported about this middle section 517 of the first elastic diaphragm 504a in a position such that the metallic structure 508 is situated within a profile area defined by the fluid chamber 512. This configuration allows the metallic structure 508 to be free from restriction of movement by the support structure 502, so that contraction of the metallic structure 508 can freely pull inwardly the middle portion 516 of the middle section 517 to relax or reduce tension about this area, thereby allowing fluid pressure to apply an upward or outward force to the middle portion 516 to make it bulge (while the peripheral end portion 522a remains fixed or anchored to the support structure 502).

As shown in FIG. 4C, a desired volume of a pressurized fluid (e.g., glycerin) can be injected through the first fluid port 521a and into the fluid chamber 512 from a fluid injection device 524. Optionally, a closed fluid loop system can be formed through the second fluid port 521b back to the fluid injection device 524. The first and second fluid ports 521a and 521b can then be sealed, thereby forming or generating a fixed fluid volume of the fluid chamber 512 that applies a uniform force to the first and second elastic diaphragms 504a and 504b. Such pressurized fluid causes the first and second elastic diaphragms 504a and 504b to deflect or bulge, as shown in FIG. 4C and described above regarding FIG. 1B. The tension driven actuator 500 of FIG. 4C is then ready for use for a particular purpose having a fixed fluid volume and pressure system. Although glycerin can be advantageously as a pressurized fluid, other non-limiting examples of suitable fluids can include water, cinnamon oil, mineral oil, optical fluid (e.g. commercially available from Cargille Labs or other similar companies), and the like. Refractive index of the pressurized fluid can also be considered when designing the lens system.

Advantageously, because the fluid chamber is sealed under fluid pressure, and because the first elastic diaphragm is under tension, there is no need to add or remove any amount of fluid to or from the fluid chamber when actuating the actuator (e.g., changing a focal length). Thus, the fluid chamber will always be a fixed fluid volume once the fluid is injected into the fluid chamber and sealed. This is because actuation does not occur via supplying fluid pressure from an external fluid supply; rather, actuation is facilitated by heating an SMA coil, for instance, that reduces pre-loaded or applied tension of the first elastic diaphragm 504a. Alternatively, a piezoelectric coil only modifies shape upon application of electrical current with either no or minimal heating, while fluid volume within the fluid chamber stays constant. This is advantageous over prior systems that require adding/removing fluid from a primary fluid chamber via an external fluid chamber or pressure supply, which are complex and bulky to implement, particularly for eyewear.

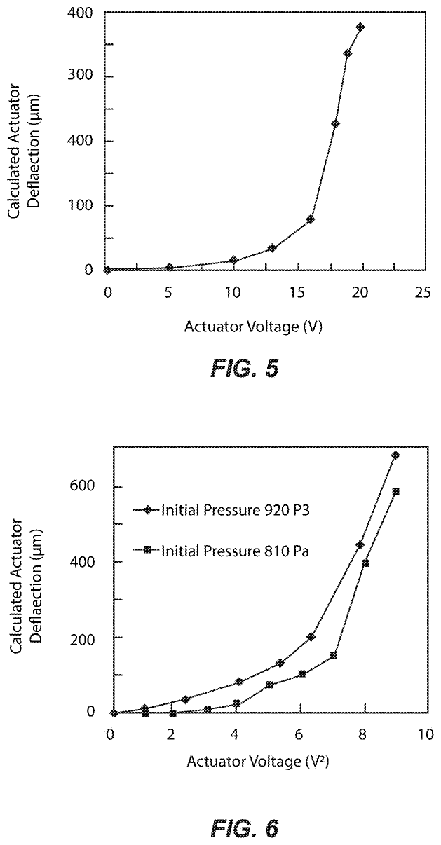

FIG. 5 is a graph that illustrates deflection vs. voltage for a particular tension driven actuator, such as the tension driven actuator 100 described above. More specifically, the results of the graph are derived from using a tension driven actuator that includes a metallic structure being an SMA coil having six coil turns, and a wire diameter of 100 micrometers with an initial resistance of about 120.2Ω, and that has pressure difference across the first diaphragm (e.g., 104a) of approximately 700 Pa. In this example, the maximum deflection (e.g., delta z) measured was about 377 micrometers in response to about 20 volts, which is achieved with a fixed fluid volume actuator, as discussed above.

FIG. 6 is a graph that illustrates the effects resulting from including different initial fluid pressures in a fluid chamber of a particular tension driven actuator, such as tension driven actuator 100 described above. This particular tension driven actuator can include a metallic structure being an SMA coil having one coil turn, and having a wire diameter of 310 micrometers. Such particular wire provides approximately eight times larger force than a 100 micrometer diameter wire, because it is much thicker in diameter (but requires more power). For this tension driven actuator having an initial fluid pressure of 920 Pa, the deflection of the first elastic diaphragm is greater than the deflection of the tension driven actuator when provided with an initial fluid pressure of 810 Pa. This is because the greater the initial fluid pressure, the greater the fluid pressure against the first elastic diaphragm when tension is reduced by the SMA coil. As shown in the graph, possible maximum deflections can range from 400-600 micrometers (e.g., on 36 mm diameter membranes) at relatively low voltages (e.g., 1V to 10V). Such results have been achieved for various SMA wire diameter and number of coil turns, such as exemplified herein.

Note that, the greater the number of turns of an SMA coil, the greater the degree of contraction, because the wire of the SMA coil is longer with more turns, and therefore will contract more than a coil with less turns and having the same diameter. Thus, the number of turns is proportionate to the contraction force applied by the SMA coil. Further note that the wire diameter of the SMA coil is also proportionate to the amount of contraction force, so the thinner the wire (e.g., 50 microns), the more turns may be required to generate a desired contraction force. And, the greater the wire diameter (e.g., 200 microns), the more power may be required to effectuate desired actuation.

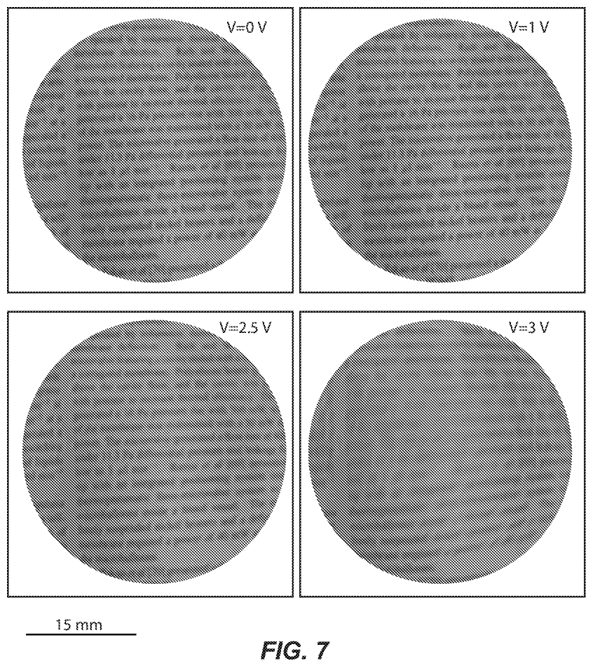

FIG. 7 show four images taken through a particular tension driven actuator (operating as an optical lens) as corresponding to four different voltages 0 V, 1 V, 2.5 V, and 3 V, respectively, and with a response bandwidth of approximately 1 Hz. These images illustrate the progressively larger optical power and greater deflection of the first elastic diaphragm upon increasing and varying voltages.

In an alternative example, FIG. 8A shows a tension driven actuator 600 in a tension diaphragm position C (i.e., prior to actuation), and FIG. 8B shows the tension driven actuator 600 in a relaxed diaphragm position D (i.e., upon actuation). The tension driven actuator 600 can be incorporated as a microfluidic valve actuator, as detailed below. More specifically, the tension driven actuator 600 can comprise a support structure 602, and an elastic diaphragm 604a and an enclosing portion 604b attached to either side of the support structure 602. In this configuration, the enclosing portion 604b is a rigid bottom wall instead of an elastic membrane. A metallic structure 608 (e.g., an SMA coil) can be coupled or attached to the elastic diaphragm 604a, similarly as described above regarding FIGS. 2A and 2B. A fluid 610 is disposed in a fluid chamber 612, and can be pressurized. The elastic diaphragm 604a and the metallic structure 608 can be pulled under tension prior to being attached to the support structure 602, similarly as described in the examples above. The fluid pressure applied by the fluid 610 can exert an outward force to the elastic diaphragm 604a to expand or bulge it prior to actuation, as shown in FIG. 8A, because of the elastic nature of the elastic diaphragm. The enclosing portion 604b in this example can be a rigid support portion that is part of the support structure 602, or that is a separate component attached to the support structure 602.

As a microfluidic valve actuator, the tension driven actuator 600 can be oriented with a microfluidic channel 650, and positioned such that the microfluidic channel 650 is closed in a diaphragm relaxed position (FIG. 8B) and open in the diaphragm tension position (FIG. 8A). The microfluidic channel 650 can be any fluid channel as shown, or can be a fluid channel through a tube or other component capable of being pinched or compressed by the tension driven actuator 600 when actuated to limit or restrict fluid (or gas) flow through a channel.

The metallic structure 608 can be coupled to a power source (not shown) controlled by a microcontroller (not shown), such that, in response to application of an electrical field, the metallic structure 608 is heated and transitions from the diaphragm tension position C (FIG. 8A) to the diaphragm relaxed position D (FIG. 8B). Accordingly, the metallic structure 608 (e.g., an SMA coil) deforms and contracts in size (e.g., length). This transition of the metallic structure 608 causes a reduction in tension of the elastic diaphragm 604a, such that fluid pressure from the fluid 610 causes deflection (or relaxation) of a middle portion 616 of the elastic diaphragm 604a, as illustrated in FIG. 9B.

Such deflection of the elastic diaphragm 604a can be used to generate an actuation force for limiting or restricting fluid flow (or gas flow), or for other applications that can benefit from a relatively large actuation force resulting from a relatively low voltage, as also discussed above. Advantageously, the volume or amount of fluid in the fluid chamber does not change before and after actuation of the tension driven actuator, because the fluid chamber comprises a fixed fluid volume. This drastically reduces the complexity of manufacturing and operating the tension driven actuators exemplified herein. Note that, in this example, the fluid pressure in the fluid chamber may slightly drop during actuation, because this tension driven actuator comprises only one elastic diaphragm (as opposed to two elastic diaphragms of FIGS. 1A and 1B), so relaxation of the elastic diaphragm 604a effectively increases the area of the fluid chamber, which may reduce fluid pressure but does not affect operation/actuation of the device.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A tension driven actuator, comprising:
a support structure formed of a peripheral bounded wall at least partially defining a fluid chamber;
a first elastic diaphragm attached, under tension, to the support structure and enclosing the fluid chamber with the support structure;
a fluid disposed in the fluid chamber; and
a tension modifier structure attached to the first elastic diaphragm, wherein the tension modifier structure is under tension with the first elastic diaphragm,
wherein, in response to application of an electrical field to the tension modifier structure, the tension modifier structure transitions from a diaphragm tension position to a diaphragm relaxed position, such that the tension modifier structure deforms and contracts in size, thereby reducing tension of the first elastic diaphragm such that fluid pressure causes deflection of a portion of the first elastic diaphragm.

2. The tension driven actuator of claim 1, further comprising an enclosing portion supported about the support structure, and further enclosing the fluid chamber.

3. The tension driven actuator of claim 2, wherein the enclosing portion comprises a rigid support structure coupled to, or formed as part of, the support structure.

4. The tension driven actuator of claim 2, wherein the enclosing portion comprises a second elastic diaphragm.

5. The tension driven actuator of claim 4, wherein the elastic diaphragms are each comprised of an optically transparent membrane, and wherein the fluid comprises an optically transparent fluid, such that the tension driven actuator is operable as an optical lens, wherein actuation of the tension driven actuator changes a focal length of the optical lens through movement of the first elastic diaphragm.

6. The tension driven actuator of claim 5, wherein the optically transparent membranes each comprise a Young modulus of elasticity from 500 Pa to 100 MPa.

7. The tension driven actuator of claim 1, wherein the tension modifier structure is a coil comprising a shape memory alloy (SMA) or a piezoelectric.

8. The tension driven actuator of claim 1, wherein the fluid is pressurized, and defines a fixed fluid volume before and after deflection of the first elastic diaphragm.

9. The tension driven actuator of claim 1, wherein the tension modifier structure is electrically coupleable to a power source operable to vary the electrical field applied to the tension modifier structure, thereby dynamically controlling an amount of tension and deflection of the first elastic diaphragm.

10. The tension driven actuator of claim 1, wherein the support structure comprises at least one fluid port for injection of the fluid into the fluid chamber during assembly of the tension driven actuator, and wherein the at least one fluid port is sealed from an external environment after injection and pressurization of the fluid, thereby sealing the fluid chamber such that fluid is not injectable into, or removable from, the fluid chamber after being sealed.

11. The tension driven actuator of claim 1, wherein tension of the first elastic diaphragm is variably controllable by varying the electrical field applied to the tension modifier structure.

12. The tension driven actuator of claim 7, wherein the coil has a diameter from 50 micrometers to 200 micrometers.

13. The tension driven actuator of claim 7, wherein the coil has a diameter of less than 200 micrometers, and wherein the first elastic diaphragm comprises a thickness of less than 2 millimeters, and wherein the fluid comprises membrane tension less than 50 N/m.

14. The tension driven actuator of claim 7, wherein the coil includes from 2 to 8 substantially concentric coil loops.

15. The tension driven actuator of claim 1, wherein the tension modifier structure comprises an SMA wire having a first length when in a martensite state, and having a second length when in an austenite state, wherein the second length is less than the first length.

16. The tension driven actuator of claim 1, wherein the first elastic diaphragm is under tension and is pre-stretched when attached to the support structure, thereby placing the tension modifier structure under tension, such that contraction of the tension modifier structure results in an inward fluid pressure force along a plane of the first elastic diaphragm to reduce tension on a portion of the elastic diaphragm to cause deflection of the first elastic diaphragm.

17. The tension driven actuator of claim 1, further comprising a power source electrically coupled to the tension modifier structure.

18. A focusing lens system comprising at least one tension driven actuator as recited in claim 1.

19. The focusing lens system of claim 18, wherein the support structure comprises an eyeglass frame, and wherein the elastic diaphragm comprises an optically transparent membrane, and the fluid comprises an optically transparent fluid, the focusing lens system further comprising a microcontroller coupled to the frame and configured to facilitate actuating the at least one tension driven actuator to move the to adjust a focal length of the at least one tension driven actuator.

20. A microfluidic valve comprising at least one tension driven actuator as recited in claim 1 oriented with a microfluidic channel and positioned such that the channel is closed in a diaphragm relaxed position and open in the diaphragm tension position.

21. A tension driven actuator for dynamically modifying a focal length, comprising:
a support structure formed of a peripheral bounded wall at least partially defining a fluid chamber;
a first transparent elastic diaphragm attached, under tension, to one side of the support structure;
a second transparent elastic diaphragm attached to another side of the support structure, such that the support structure and the first and second transparent elastic diaphragms define a fluid chamber;
a transparent fluid disposed in the fluid chamber, the transparent fluid being pressurized to apply a force to the first and second transparent elastic diaphragms;
a tension modifier coil structure attached to the first transparent elastic diaphragm; and
a power source electrically coupled to the tension modifier coil structure, wherein the coil structure deforms and contracts upon application of an electrical field to the coil structure, thereby reducing tension of the first transparent elastic diaphragm such that fluid pressure causes deflection of a portion of the first transparent elastic diaphragm to modify a focal length of the tension driven actuator.

22. The tension driven actuator of claim 21, wherein a degree of deflection of the first transparent elastic diaphragm corresponds to an amount of tension of the first transparent elastic diaphragm, an amount of voltage applied to the coil structure, an amount of fluid pressure of the transparent fluid, and a number of turns of the coil structure.
